(19) United States
(12) Patent Application Publication
(10) Pub. No.: US 2008/0022875 A1
(43) Pub. Date: Jan. 31, 2008

(54) Sheet-fed printing press

(75) Inventors: Katsushi Hirokawa, Fuchu-shi (JP); Hiroyuki Kuroki, Fuchu-shi (JP)

Correspondence Address: TECHNOLOGY & INTELLECTUAL PROPERTY;STRATEGIES GROUP PC (dba TIPS GROUP), P. O. BOX 1639, LOS ALTOS, CA, 94023-1639, US

(73) Assignee: RYOBI LTD., Fuchu-shi (JP)

(21) Appl. No.: 11/880,713

(22) Filed: Jul. 23, 2007

(30) Foreign Application Priority Data
Jul. 25, 2006 (JP) 2006-201797

(51) Int. Cl. B41F 1/30

(52) U.S. Cl. 101/409; 156/379.6; 156/387

(57) ABSTRACT

A sheet-fed printing press includes a printing section for printing on sheets of paper fed from a sheet feeding section, and a surface treating section for treating surfaces of the sheets of paper by pressing transfer films respectively onto the sheets of paper printed at the printing section. The surface treating section includes a downstream cylinder having a gripper for gripping each of the sheets of paper fed from an upstream cylinder for conveying the sheets of paper printed and fed thereto, and a film transfer mechanism that presses the transfer films respectively onto the sheets of paper on the downstream cylinder while at the same time conveying the transfer films in the same direction as the direction of the downstream cylinder.

### CROSS REFERENCE TO RELATED APPLICATION

This application claims priority from Japanese Patent Application No. 2006-201797, which is incorporated herein by reference.

### BACKGROUND OF THE INVENTION

1. Field of the Invention

The present invention relates to a sheet-fed printing press that enhances the added value of a printed sheet of paper by pressing a transfer film on the printed sheet, thus transferring gold foil, embossed pattern, hologram pattern, etc. on the transfer film.

2. Related Art

There was proposed a gloss-finishing machine that enhances the added value of a printed sheet of paper (hereinafter referred simply to as “printed sheet”) in the manner mentioned above. This machine includes a sheet feeding mechanism for feeding of printed sheets, a registering unit for positioning the fed sheets with respect to a sheet conveying direction and a sheet lateral direction, a belt conveyor for conveying in a horizontal direction each sheet positioned by the registering unit, a pressing roller disposed on the upstream side of the belt conveyor for pressing a resin film, which is fed from a film conveying mechanism, onto a printed surface of each sheet, a receiving roller disposed just under the pressing roller, and an ultraviolet irradiation lamp for irradiating ultraviolet rays onto the resin film, which has been integrated with each sheet by the pressing roller, from above, in which the printed surface of each sheet is processed, while being conveyed along a straight path in a horizontal direction (e.g., Patent Document 1).

[Patent Document 1] Japanese Examined Patent Application Publication No. Hei-07-106627 (cf. FIG. 1)

The horizontal arrangement of the sheet feeding mechanism, the registering unit, the pressing roller and the belt conveyor in the gloss-finishing machine of Patent Document 1 causes not only increase in the entire size of the machine, but also the necessity to install the machine independently of the sheet-fed printing press, which in turn causes not only a disadvantage of necessitating a large space for installation, but also a disadvantage of causing a troublesome work to remove each printed sheet to the gloss-finishing machine.

In addition, a special-purpose gloss-finishing machine made up of the sheet feeding mechanism, the registering unit, the pressing roller, the belt conveyor, etc. provided independently of the sheet-fed printing press causes a disadvantage on the cost side.

In consideration of the above, it is an object of the present invention to provide a sheet-fed printing press that is advantageous in terms of installation space and cost, while being capable of successively carrying out the surface treatment to enhance the added value of a printed surface of each printed sheet.

### SUMMARY OF THE INVENTION

According to the present invention, there is provided a sheet fed printing press that includes a printing section for printing on sheets of paper fed from a sheet feeding section, and a surface treating section for treating surfaces of the sheets of paper by pressing transfer films respectively onto the sheets of paper printed at the printing section, in which the surface treating section includes a downstream cylinder having a gripper for gripping each of the sheet of paper fed from an upstream cylinder for conveying the sheets of paper printed and fed thereto, and a film transfer mechanism that presses the transfer films respectively onto the sheets of paper on the downstream cylinder while at the same time conveying the transfer films in the same direction as the direction of the downstream cylinder.

With the sheet-fed printing press having the above structure, it is possible to convey each sheet of paper printed at the printing section to a downstream side while keeping its original position as it was fed (especially relative to the lateral width direction) by gripping the sheet of paper by the gripper mounted in the downstream cylinder. Then, the transfer films can be transferred respectively onto the sheets of paper by pressing the transfer films onto the sheets of paper, which are conveyed by the rotation of the cylinder. As the transfer films, it can be cited those enabling gold foil, embossed pattern or hologram pattern to be transferred to sheets of paper. Further, it is possible to employ those enabling a plain film to be pressed onto a sheet of paper, thereby smoothing a surface of varnish, or enabling application of a glossy finish or matt finish to a sheet of paper.

The sheet-fed printing press may further include a varnish coating section for coating the printed sheets of paper with ultraviolet curing resin varnish, and an ultraviolet irradiation section for curing the ultraviolet curing resin varnish coated at the varnish coating section, in which both the treatments are made in a time before finishing the surface treatment at the surface treating section.

The gripper may be structured so as to be capable of being brought into a projected position at which the gripper is projected radially outwardly from the circumference of the downstream cylinder, and a retracted position at which the gripper is retracted radially inwardly from the circumference of the downstream cylinder, in which the gripper is held at the retracted position during each of the transfer films is pressed onto each of the sheets of paper.

It is possible to employ an arrangement, in which the gripper is mounted in the downstream cylinder to be pivotally movable around an axis parallel to a rotational axis of the downstream cylinder, and a cam follower, which moves along a cam face of a cam, is mounted to a portion opposite to the side on which the pivoting axis of the gripper is located, so that the gripper is movable between the projected position and the retracted position by the movement of the cam follower along the cam face.

The gripper may be structured so that during each of the transfer films is pressed onto the sheets of paper, the gripper is opened so as to release the sheet of paper from the gripped engagement with the gripper, thereby allowing the sheet of paper to be conveyed while being held between the circumference of the downstream cylinder and the transfer film.

It is possible to employ an arrangement, in which the sheets of paper are conveyed while the gripper is moved between the projected position and the retracted position when the transfer films are used, and the sheets of paper are conveyed while the gripper is held unmoved at the projected position when the transfer films are not used.

By providing the surface treating section for the surface treatment of the printed sheets, it is possible to provide a sheet-fed printing press that is capable of successively carrying out the surface treatment to enhance the added value of a printed surface of each printed sheet, omitting the necessity to remove each printed sheet to a gloss-finishing machine, and hence has a high commercial value. In addition, by utilizing the gripper provided in the downstream cylinder, it is possible to convey each sheet of paper to a downstream side for the next step while keeping its original position as it was fed (especially relative to the lateral width direction), and omit the necessity to provide an exclusively used positioning mechanism, while making it possible to prevent positional deviation of each sheet and hence enhance the registration accuracy. Further, the arrangement in which the transfer films are pressed respectively onto the sheets of paper while the sheets of paper are being conveyed by the rotation of the cylinder can reduce the space in a horizontal direction as compared with an arrangement in which sheets of paper are conveyed along a straight path, and hence it is possible to provide a sheet-fed printing press that is advantageous in terms of installation space and cost.

The application of a glossy finish to each sheet of paper can be achieved by providing a varnish coating section for coating the printed sheets of paper with ultraviolet curing resin varnish, and an ultraviolet irradiation section for curing the ultraviolet curing resin varnish coated at the varnish coating section, in which both the treatments are made in a time before finishing the surface treatment at the surface treating section. There is another advantage in that the smoothing of the surface of resin varnish can be achieved by pressing a transfer film onto resin varnish.

By employing an arrangement in which the gripper is capable of being brought into a projected position at which the gripper is projected radially outwardly from the circumference of the downstream cylinder, and a retracted position at which the gripper is retracted radially inwardly from the circumference of the downstream cylinder, in which the gripper is held at the retracted position during the transfer films are pressed respectively onto the sheets of paper, it is possible to securely prevent the gripper from being brought into contact with the transfer films during pressing by the gripper and hence breaking the transfer films, and therefore prevent any troubles with the gripper.

It is possible to inhibit operation defects such as erroneous detection, and hence improve the reliability of the operation when the gripper is to be changed in position based on the detected information from a sensor or the like, by employing an arrangement, in which the gripper is mounted in the downstream cylinder to be pivotally movable around an axis parallel to a rotational axis of the downstream cylinder, and a cam follower, which moves along a cam face of a cam, is mounted to a portion opposite to the side on which the pivoting axis of the gripper is located, so that the gripper is movable between the projected position and the retracted position by the movement of the cam follower along the cam face.

Even in a case where there is caused a difference between the rotational speed of the downstream cylinder and the feeding speed of the transfer films, it is possible to securely prevent the occurrence of troubles such as creasing of sheets, by the arrangement, in which the gripper is structured so that during the transfer films are pressed respectively onto the sheets of paper, the gripper is opened so as to release each sheet, thereby allowing the sheet to be conveyed while being held between the circumferential of the downstream cylinder and the transfer film.

### BRIEF DESCRIPTION OF THE DRAWINGS

The above, and other objects, features and advantages of the present invention will become apparent from the detailed description thereof in conjunction with the accompanying drawings wherein.

FIG. 1 is a schematic side view of a sheet-fed printing press.

FIG. 2 is an enlarged side view of a surface treating section.

FIG. 3 is a side view illustrating the motion of a claw in the surface treating section.

FIG. 4 is a plan view of a partially cross sectioned essential portion, illustrating a rotational drive mechanism for claws and a pivotal movement drive mechanism for a holder.

FIG. 5 is a perspective view of a holder.

FIG. 6 is a schematic side view of another sheet-fed printing press.

FIG. 7 is a side view of an essential portion illustrating a pressing roller that has been moved upward.

FIG. 8 is a plan view of a partially cross-sectioned essential portion, illustrating another rotational drive mechanism for claws and another pivotal movement drive mechanism for a holder.

FIGS. 9A and 9B are side views of two cams overlapped each other, and FIG. 9C is a plan view of two cams overlapped each other.

### DETAILED DESCRIPTION OF THE PREFERRED EMBODIMENT

Now, the description will be made for embodiments of the present invention with reference to the drawings attached hereto.

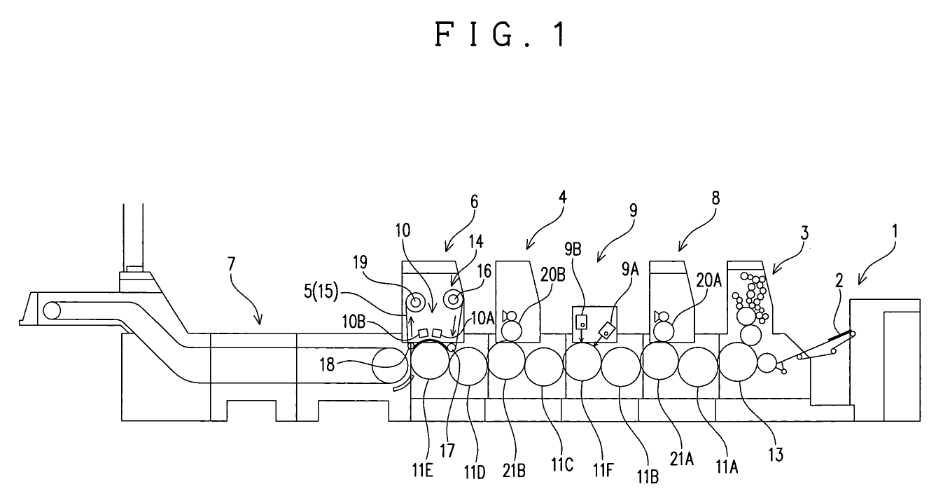

FIG. 1 illustrates an example of a sheet-fed printing press that is capable of treating a printed surface of a sheet by applying a glossy finish to the printed sheet by coating resin varnish thereon, and then transferring gold foil, embossed pattern, hologram pattern, etc., thereto. The sheet-fed printing press includes a sheet feeding section 1 for feeding sheets 2 one by one from a sheet stacking table by a feeder unit or sheet separation unit, a printing section 3 for printing on the sheets 2 fed from the sheet feeding section 1, a varnish coating section 4 for coating the sheets 2 printed at the printing section 3 with ultraviolet curing resin varnish, a surface treating section 6 for surface treatment of the sheets 2 by pressing a transfer film 5 on the ultraviolet curing resin varnish coated on the sheets 2 at the varnish coating section 4, and a sheet discharging section 7 for discharging the sheets 2 whose surfaces have been treated at the surface treating section 6. Herein, although the printing section 3 as illustrated prints one color, it is a matter of course to employ a printing section that can print two or more colors. Although the sheet discharging section 7 as illustrated is made up of a chain conveying device having later-described grippers, it is a matter of course to employ a sheet-fed printing press that does not have the sheet discharging section 7. A specific structure of each constitutional element of the sheet-fed printing press is not necessarily limited to the structure illustrated in the drawings.

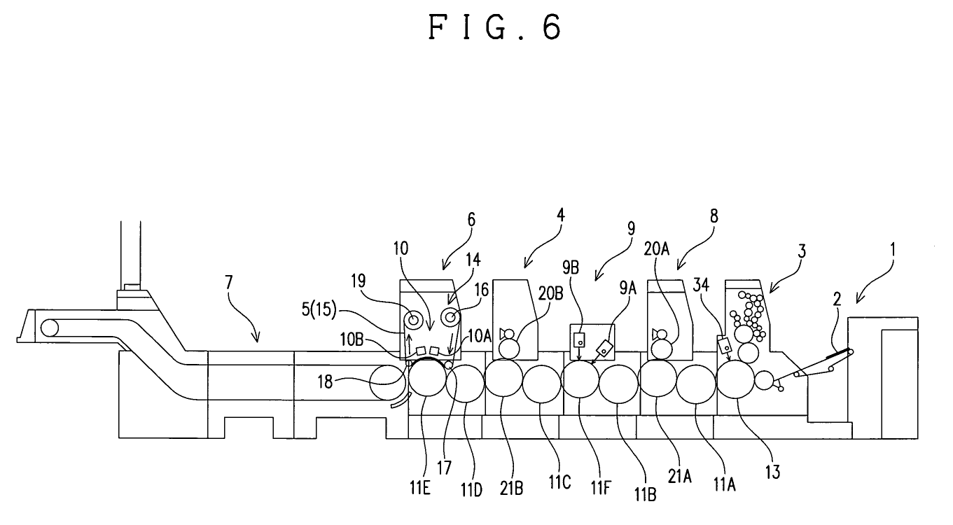

An ultraviolet irradiation section 34 for ink curing may be disposed to irradiate ultraviolet rays on a printed surface of each sheet 2 immediately after it has been printed, as illustrated in FIG. 6. It is possible to enhance glossiness of a surface by first curing ink with exposure to ultraviolet radiation, and then coating the surface with varnish.

Disposed upstream of the varnish coating section 4 in the conveying direction of sheets 2, and more specifically disposed in tandem at an exit of the printing section 3 are second varnish coating section 8 for coating ultraviolet curing resin varnish and a second ultraviolet irradiation section 9 for irradiating ultraviolet rays onto the ultraviolet curing resin varnish coated at the second varnish coating section 8, thereby curing (drying) the resin varnish. An ultraviolet irradiation section 10 for irradiation of ultraviolet rays is disposed at a position enabling irradiation of ultraviolet rays from above onto a transfer film 5 attached on a printed surface of each sheet 2, or disposed within the surface treating section 6 to cure (dry) the ultraviolet curing resin varnish coated at the varnish coating section 4. Although the thus provided second varnish coating section 8 enables coating of the same type or a different type of ultraviolet curing resin varnish, this second varnish coating section 8 may be omitted. When omitting the second varnish coating section 8, the second ultraviolet irradiation section 9 is necessarily omitted. It is also possible to omit the varnish coating section 4 and the ultraviolet irradiation section 10, while maintaining only the surface treating section, depending on the case. The ultraviolet irradiation section 9 or 10 is made up of two ultraviolet irradiation lamps 9A and 9B, or 10A and 10B. In place of these two lamps, it is possible to employ an arrangement of a single lamp or three or more lamps. The varnish coating section 4 or 8 includes a varnish cylinder 20A or 20B to which ultraviolet curing resin varnish is supplied, and an impression cylinder 21A or 21B disposed facing the corresponding varnishing cylinder 20A or 20B to coat each printed sheet 2 with ultraviolet curing resin varnish, and a transfer cylinder 11A or 11C for transferring each sheet 2 to these cylinders. In this arrangement, transfer cylinders 11A to 11D are provided to the respective sections so as to be unitedly arranged to form the respective units. Instead, these transfer cylinders 11A to 11D may be arranged respectively as separate units. A reference numeral 13 in FIG. 1 represents an impression cylinder disposed in the printing section 3. The ultraviolet irradiation lamps 9A and 9B are provided with a second transfer cylinder 11F for receiving sheets 2 transferred by the transfer cylinder 11b and allowing the same to be irradiated with ultraviolet rays from the ultraviolet irradiation lamps 9A and 9B while transferring those sheets 2.

The surface treating section 6 includes a downstream cylinder (second transfer cylinder) 11E having grippers 12 respectively mounted at two positions (or three or more positions) or a gripper 12 mounted at one position, in the circumferential direction of the cylinder 11E to grip each sheet 2 coming from the upstream cylinder (first transfer cylinder) 11D for transferring the printed and fed sheets 2, and a film transfer mechanism 14 that conveys the transfer film 5 in the same direction as the direction of the downstream cylinder 11E, and pressing and attaching the transfer film 5 onto an oncoming sheet 2 on the cylinder 11E during conveyance, while utilizing the ultraviolet curing resin varnish coated at the varnish coating section 4 as adhesive. A surface of a sheet 2 with the ultraviolet curing resin varnish coated thereon can be smoothened by pressing the transfer film 5 onto the ultraviolet curing resin varnish, so that the glossiness can be enhanced. The ultraviolet curing resin varnish is cured by irradiating ultraviolet rays of the ultraviolet irradiation lamps 10A and 10B onto the pressed transfer film 5.

The film transfer mechanism 14 is disposed above the downstream cylinder 11E, and includes an elongated substrate film 15 for film transfer having a large number of transfer films 5 that are continuously disposed thereon or interruptedly disposed thereon with a predetermined distance from each other, a feed roll 16 for feeding this substrate film 15, a pair of pressing rollers 17, 18 for pressing the substrate film 15 fed from the feed roll 16 onto each sheet 2 on the downstream cylinder 11E, thereby attaching the transfer films respectively to the sheets 2, and a winding roll 19 for winding the substrate film 15 by moving the same upward away from the pressing roller 18 disposed downstream of the sheet transfer direction, thereby transferring the transfer films 5 respectively onto the sheets 2. Although two pressing rollers 17, 18 are disposed in the arrangement as illustrated herein, three or more pressing rollers may be disposed, or alternatively only the one pressing roller may be disposed. The feed roll 16 or the winding roll 19, or both may also be used to function as the pressing rollers 17, 18, which contributes to the reduction of the number of parts and size of the sheet-fed printing press.

The power of the cylinder 11E may be utilized to drivingly rotate the winding roll 19, while at the same time synchronizing the rotational speed of the cylinder 11E with the feeding speed of the substrate film 15. In a case where the feed roll 16 and the winding roll 19 are used also to function as the pressing rollers 17, 18, it is possible to omit the necessity to provide an interlocking mechanism for feeding and winding up of the substrate film 15 by rotating both the rolls 16, 19 following the rotation of the cylinder 11E, while at the same time holding both the rolls 16, 19 in a freely rotatable state. This produces an advantage of simplifying the structure.

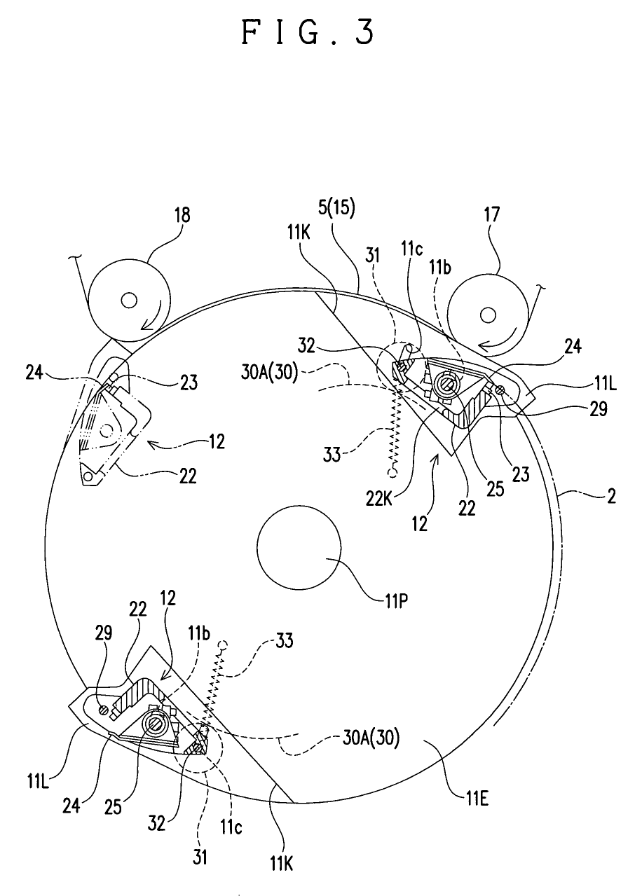

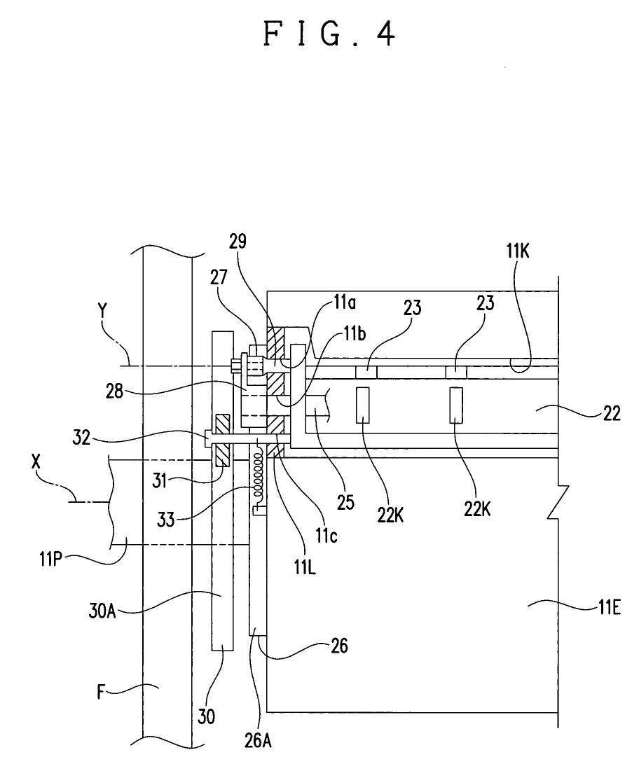

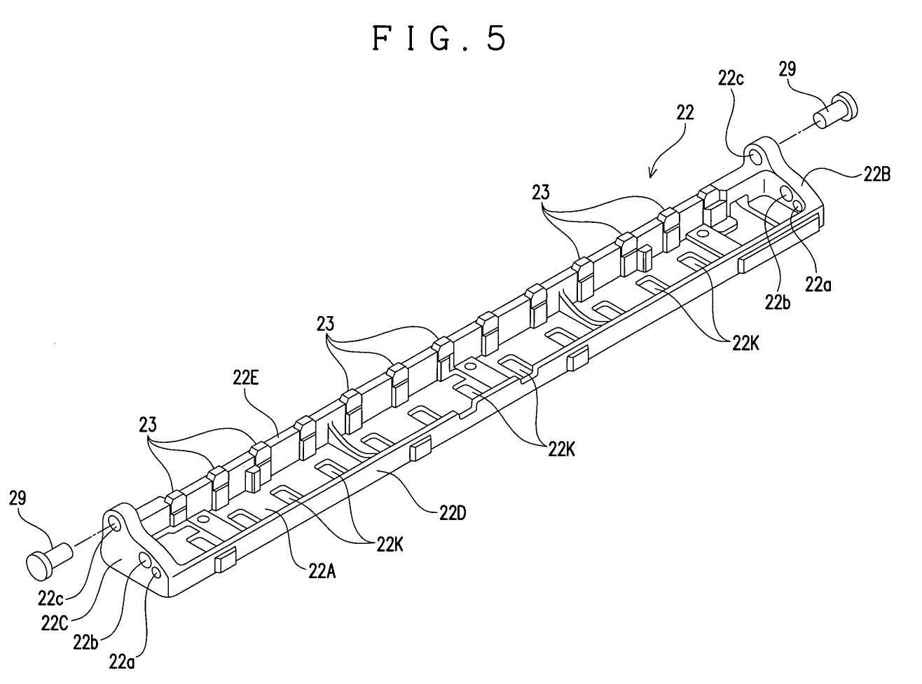

The grippers 12 each include, as illustrated in FIGS. 3 to 5, a laterally elongated holder 22, plural claw blocks 23 fixed to the holder 22 with a predetermined distance from each other, and plural and more specifically the same number of claws 24 as the number of the claw blocks 23 (only a single claw is illustrated in FIGS. 3 and 4) that are mounted to a rotational shaft 25, which extends through and is supported by the holder 22, to be integrally rotatable with the rotational shaft 25 and are rotatably urged by springs (not shown) towards the corresponding claw blocks 23 so as to grip a sheet 2 positioned along the upper ends of the claw blocks 23. The holder 22 has a laterally elongated bottom wall 22A having four sides, namely first and second lateral sides and front and rear sides, lateral side walls extending upwards respectively from the first and second lateral sides, each wall having an upper edge gradually extending upward as it advances towards the back side, and front and rear walls 22D and 22E extending upwards respectively from the front and rear sides, and the aforesaid claw blocks 23 disposed on the rear wall 22E with a predetermined distance from each other. The bottom wall 22A has escape holes 22K for preventing lower ends of the claws 24 from contacting the bottom wall 22A when the claws 24 are rotated into open positions. The lateral side walls 22B, 22C each have three through-holes 22a, 22b, 22c arranged in the front and rear direction, and the rotational shaft 25 is inserted through the through-holes 22b, 22b each located intermediate between the through-holes 22a and 22c in the front and rear direction to have opposite ends, to each of which a proximal end of an arm 28 is integrally rotatably supported, in which the arm 28 has a distal end mounted with a cam follower 27 that runs along an outer face (cam face) 26A of a corresponding cam 26. The cam followers 27 run along the cam faces 26A as the cylinder 11E rotates, so that the claws 24 rotated and held at closing positions, at which the claws contact the claw blocks 23, are brought into releasing positions upon rotation of the rotational shaft 25 in synchronization with the conveying timing of each sheet 2, then a leading end of each sheet 2 is allowed to be entered into a space between the claw blocks 23 and the claws 24, then the claws are rotated to be brought into the closing positions, thereby gripping the sheet 2, then the claws 24 are brought into the open positions with respect to the claw blocks 23 so as to release the sheet 2 in synchronization with the next releasing timing. The holder 22 is disposed in a corresponding cutout 11K formed in the cylinder 11E. The front positioned through-holes 22a each are for fixedly receiving later-described pins 32.

The grippers 12 are structured so as to be capable of being brought into a projected position at which the grippers are projected radially outwardly from the circumference of the downstream cylinder 11E (a position of the gripper illustrated in a lower side of FIG. 3, at which the claws 24 of the gripper 12 are held at the open positions), and a retracted position at which the grippers are retracted radially inwardly from the circumference (a position of the gripper illustrated in an upper side of FIG. 3). The grippers 12 are held at the retracted position during a transfer film 5 is pressed onto a sheet 2, thereby preventing the transfer film 5 or the substrate film 15 from being cut by the contact with the grippers 12. In FIG. 3, the grippers 12 are held at the retracted position until the gripper 12 located in the upper side is moved to a position represented by chain double-dashed lines.

More specifically, pivot pins 29 are inserted into holes l a of opposite lateral side walls 11L that together form each cutout 11K of the downstream cylinder 11E, and then inserted into the through-holes 22c, 22c formed in the lateral walls 22B, 22C of the holder 22 of each gripper 12, so that the holder 22 is entirely and pivotally movable around an axis Y parallel to an axis X of the rotational shaft 11P of the cylinder 11E. A cam follower 31, which moves along a cam face 30A of a cam 30, is mounted via a pin 32 to a portion opposite to the side on which the pivot pins 29 of the holder 22 are mounted, so that each gripper 12 is shiftable between the aforesaid two positions by the movement of the cam follower 31 along the cam face 30A. The holder 22 is urged towards the retracted position by a coil spring 33 mounted between the pin 32 and the cylinder 11E, thereby preventing the cam follower 31 from being lifted upward away from the cam face 30A. The rotational shaft 11P of the cylinder 11E extends through a frame F illustrated in FIG. 4 and is supported by the same. Although in FIG. 4, only the structure of the one side of the cylinder 11E is illustrated, the same structure is also employed for the opposite side of the cylinder 11E. The rotational shaft 25 and the pins 32 that project laterally outwards from the holder 22 are supported in elongated holes 11b, 11c, each formed into an arc-shape extending in the vertical direction in the wall 11L. It is a matter of course that the shape of the wall 11L, and the support structure of each of the rotational shaft 25, the pivot pins 29 and the pins 32 are not necessarily limited to those illustrated in Figures.

Accordingly, the gripper 12 of the downstream transfer cylinder 11E, which has gripped a leading end of a sheet 2 coming from the upstream transfer cylinder 11D, is retracted towards the cutout 11K and brought into the retracted position, (the position taken by the gripper 12 illustrated in the upper side of FIG. 3), just before the substrate film 15 is pressed onto the sheet 2 on the transfer cylinder 11E by the pressing roller 17 located on the starting side, and is brought into the projected position, (the position taken by the gripper 12 illustrated in the lower side of FIG. 3 at which the claws 24 of the gripper 12 are held at the open positions), just after the substrate film 15 has been released from the pressed engagement with the pressing roller 18 located on the end side, that is, when the gripper 12 has been moved to the position represented by the chain double-dashed lines in FIG. 3. After the gripper 12 has been shifted to the projected position and the transfer of the sheet 2 to the sheet discharging section 7 has been finished, the claws 24 are opened with respect to the claw blocks 23 (like the gripper 12 illustrated in the lower side of FIG. 3). With the claws 24 held opened with respect to the claw blocks 23, as illustrated by the gripper 12 in the lower side of FIG. 3, a sheet 2 is brought onto the claw blocks 23, so that the sheet 2 is gripped by closing the claws 24. With this gripping state, the gripper 12 is brought into the retracted position just before the substrate film 15 is pressed onto the sheet 2 on the transfer cylinder 11E, since the transfer of the sheet 2 to the sheet discharging section 7 has been finished.

In a case where there is caused a difference between the rotational speed of the cylinder 11E and the feeding speed of the substrate film 15 even when the winding roll 19 is drivingly rotated while synchronizing those speeds, it is possible to employ an operation in which a sheet 2 is released from the gripped engagement with the gripper 12 just before the substrate film 15 is pressed onto the sheet 2 on the transfer cylinder 11E, and the sheet 2 is again gripped by closing the gripper 12 just after the substrate film 15 is released from the pressed engagement with the pressing roller 18. This operation prevents the sheet 2 from being creased due to the difference in speed. In summary, during the transfer film 5 is pressed onto the sheet 2, the gripper is held opened, thereby releasing the sheet 2 and therefore the sheet is conveyed while being clamped between the circumference of the downstream cylinder 11E and the transfer film 5.

The above description was made by taking, for example, an arrangement in which each gripper 12 can be shifted into the retracted position, it is possible to employ an arrangement in which each gripper 12 cannot be shifted into the retracted position, so that the surface treatment is made, while constantly holding each gripper 12 at the same projected position. In this case, it is possible to employ an arrangement in which the pressing roller 17 is movable in the vertical direction so as to allow the substrate film 15 to be pressed onto a sheet 2 on the transfer cylinder 11E by the pressing roller 17 just after the gripper 12 has passed the pressing roller 17.

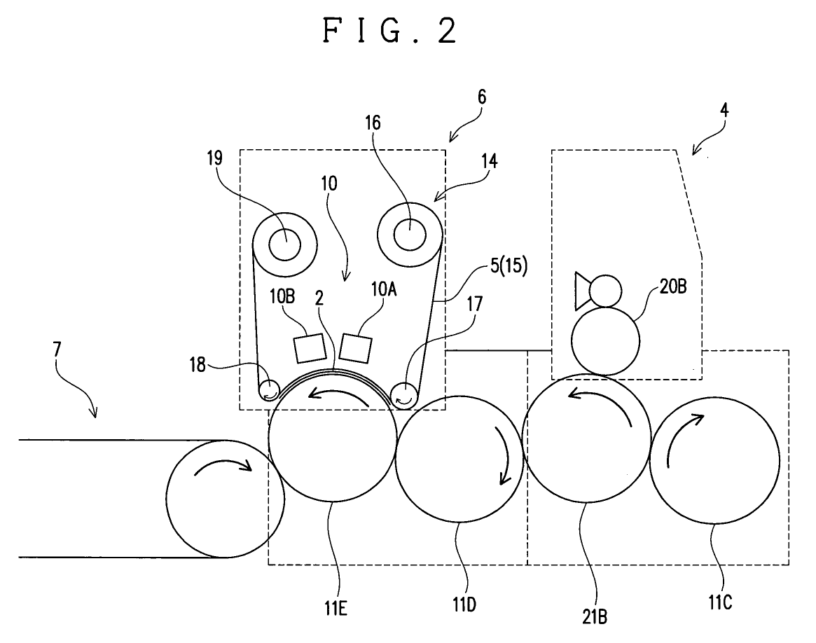

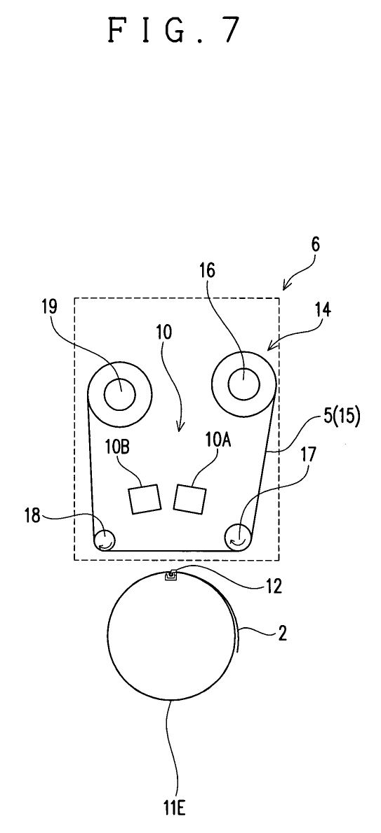

FIG. 7 illustrates an optional arrangement, in which when the transfer film 5 is to be used, the gripper 12 conveys the sheet 2 as being moved between the projected position and the retracted position; and when the transfer film 5 is not to be used, the gripper 12 conveys the sheet 2 as being held at the projected position. Specifically, the pressing rollers 17, 18 are so structured as to be moved upward and downward by using a lifting device (not shown), and when the transfer film 5 is not to be used, the pressing rollers 17, 18 are lifted up to an upper position. When the transfer film 5 is to be used, the pressing rollers 17, 18 are lowered to a lower position by using the lifting device, as illustrated in FIG. 2.

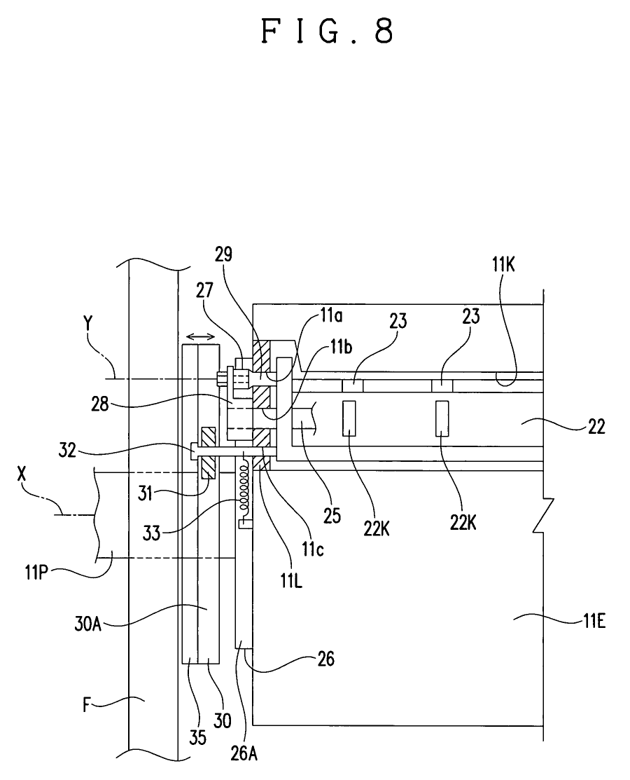

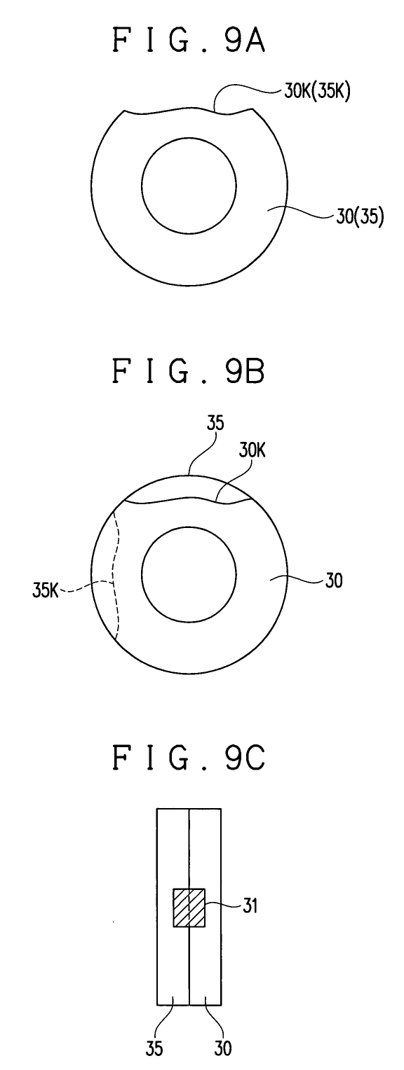

Now, the description will be made for an arrangement, in which an operation is shifted between a film-use-mode allowing each gripper 12 to be moved between the projected position and the retracted position for the operation using the transfer film 5, and a film-nonuse-mode allowing each gripper 12 to be held at the projected position for the operation not using the transfer film 5. As illustrated in FIG. 8, a circular, second cam 35 having no cutout is disposed outside of the cam 30 having a cutout for allowing the gripper 12 to be brought into the retracted position of FIG. 4 (in FIG. 9A, the cam 30 having a cutout 30K is illustrated). Two cams 30, 35 are structured so as to be able to be moved in the arrow direction (the rotational axis direction of the transfer cylinder 11E). When the cam follower 31 of FIG. 8 runs along the cam face of the cam 30, the gripper 12 is so shifted as to be able to be held at the retracted position during the movement along the cutout 30K, and held at the projected position during the movement along an arced portion (a portion other than the cutout 30K). When the cam follower 31 runs along the cam face of the second cam 35, the griper 12 is constantly held at the projected position. In FIG. 8, the two cams 30, 35 are moved in the arrow direction, while it is possible to employ an arrangement in which the cam follower 31 is moved in the rotational axis direction of the transfer cylinder 11E into a position allowing itself to lie on the cam 30 and a position allowing itself to lie on the second cam 35.

It is also possible to employ an arrangement in which the cam follower 31 and the two cams 30, 35 are not movable in the axis direction, while the rotational position of each of the two cams 30, 35 are changed, so that the operation is shifted between the two modes. Specifically, as illustrated in FIG. 9C, a cam follower 31 having a lateral width large enough to contact at the same time both the cam faces of the two cams 30, 35 having the same structure is prepared. The two cams 30, 35 are structured to be rotatable to each other so as to have the cutouts 30K, 35K of the two cams 30, 35 located at the same circumferential position in the rotational direction (see FIG. 9A), and have the cutouts 30K, 35K of the two cams 30, 35 located at different circumferential positions from each other in the rotational direction (see FIG. 9B). Accordingly, at the position as illustrated in FIG. 9A, the operation is kept in a film-use mode in which the gripper 12 is located at the retracted position only during the movement along the cutouts 30K, 35K; and at the position as illustrated in FIG. 9B, the operation is kept in a film-nonuse mode in which the griper 12 is constantly held at the projected position.

This specification is by no means intended to restrict the present invention to the preferred embodiments set forth therein. Various modifications to the sheet-fed printing press, as described herein, may be made by those skilled in the art without departing from the spirit and scope of the present invention as defined in the appended claims.

What is claimed is:

1. A sheet-fed printing press comprising a printing section for printing on sheets of paper fed from a sheet feeding section, and a surface treating section for treating surfaces of the sheets of paper by pressing transfer films respectively onto the sheets of paper printed at the printing section, said surface treating section including a downstream cylinder having a gripper for gripping each of the sheets of paper fed from an upstream cylinder for conveying the sheets of paper printed and fed thereto, and a film transfer mechanism that presses the transfer films respectively onto the sheets of paper on the downstream cylinder while at the same time conveying the transfer films in the same direction as the direction of the downstream cylinder.

2. The sheet-fed printing press according to claim 1, further comprising a varnish coating section for coating the printed sheets of paper with ultraviolet curing resin varnish, and an ultraviolet irradiation section for curing the ultraviolet curing resin varnish coated at the varnish coating section, in which both the treatments are made in a time before finishing the surface treatment at the surface treating section.

3. The sheet-fed printing press according to claim 1, wherein the gripper is structured so as to be capable of being brought into a projected position at which the gripper is projected radially outwardly from the circumference of the downstream cylinder, and a retracted position at which the gripper is retracted radially inwardly from the circumference of the downstream cylinder, in which the gripper is held at the retracted position during each of the transfer films is pressed onto each of the sheets of paper.

4. The sheet-fed printing press according to claim 3, wherein the gripper is mounted in the downstream cylinder to be pivotally movable around an axis parallel to a rotational axis of the downstream cylinder, and a cam follower, which moves along a cam face of a cam, is mounted to a portion opposite to the side on which the pivoting axis of the gripper is located, so that the gripper is movable between the projected position and the retracted position by the movement of the cam follower along the cam face.

5. The sheet-fed printing press according to claim 3, wherein the gripper is structured so that during each of the transfer films is pressed onto each of the sheets of paper, the gripper is opened so as to release said sheet of paper from the gripped engagement with the gripper, thereby allowing said sheet of paper to be conveyed while being held between the circumference of the downstream cylinder and the transfer film.

6. The sheet-fed printing press according to claim 3, wherein the sheets of paper are conveyed while the gripper is moved between the projected position and the retracted position when the transfer films are used, and the sheets of paper are conveyed while the gripper is held unmoved at the projected position when the transfer films are not used.
